(19) United States
(12) Patent Application Publication
(10) Pub. No.: US 2024/0313549 A1
(43) Pub. Date: Sep. 19, 2024

(54) Circuit For Battery Storage Management And Method For Battery Storage Management In This Circuit

(71) Applicant: Ceska Energeticko-Auditorska Spolecnost, S.R.O., Praha (CZ)

(72) Inventors: Milan Turena, Dasice (CZ); Ludvik Dolecek, Dasice (CZ); Jaroslav Stasek, Dolni Roven (CZ); Miloslav Kolman, Dolni Horice (CZ)

(73) Assignee: Ceska Energeticko-Auditorska Spolecnost, S.R.O., Praha (CZ)

(21) Appl. No.: 18/270,378

(22) PCT Filed: Dec. 30, 2021
(86) PCT No.: PCT/CZ2021/050161

§ 371 Date: Jun. 29, 2023

(30) Foreign Application Priority Data
Dec. 30, 2020 (CZ) PV2020-731

(51) Int. Cl. H02J 7/00; H01M 10/42; H01M 10/44; H01M 10/48

(52) U.S. Cl. CPC H02J 7/0014; H01M 10/425; H01M 10/441; H01M 10/482; H01M 10/486; H02J 7/0031; H02J 7/0047; H01M 2010/4271

(57) ABSTRACT

A circuit for battery storage management where the storage contains at least two cells (4.i) connected in at least one bank (10), at least one device (11) for controlling the bank, at least one main power supply bus (8) and at least one communication bus (9). At least one cell (4.i) is equipped with at least one cell management device (3) with measurement devices for measuring cell status indicators. Each device (11) for controlling the bank (10) contains a control unit and memory storage blocks for storing values regarding the history of each cell (4.i). The circuit contains an independent power source and an auxiliary power supply bus (7) powered from it which connects each device (11) for controlling the bank (10) to the cell management devices (3) contained in this bank (10). A method for battery storage management in this circuit is also proposed, in which the cell status indicators (4.i) are measured and in the event of a predicted failure, the cells (4.i) are recharged via the auxiliary power bus (7).

### TECHNICAL FIELD

The invention concerns management of a battery storage (English acronym BMS for Battery Management System), in particular the active balancing of this battery storage.

### BACKGROUND OF THE INVENTION

The vast majority of BMS are passive—during charging, these types discharge the cells with the highest voltage of the resistor or transistor until the cell with the lowest voltage is fully charged by comparing cell voltages—the efficiency is low and waste heat generation is significant. Many authors manage this balancing method using a processor and call it active balancing.

They incorrectly list a method in which excess energy is converted to heat, where the process of discharging cells to generate waste heat is controlled by electronics or even software means, as active balancing; see e.g. https://www.dps-az.cz/soucastky/id:24793/inteligentni-rizeni-baterii-pro-prumyslove-aplikace. In these solutions, the excess energy is converted into heat, so it is not possible to draw energy from the battery cell without converting this energy into waste heat.

If interpreted correctly, active balancing should consist in drawing power from the strongest cells and transferring power to the weaker cells—in this scenario, the only source of heat is the power dissipation rate given by the efficiency of the device, which is usually less than 100%. In these solutions, the voltage of cells is almost always evaluated and compared with each other. This solution is limited in that it is necessary for a single battery storage to contain identical cells (matching type, voltage, internal resistance, etc.). The mere use of cells of the same type but different age within the same storage does not allow operating the storage or BMS without limitations. The disadvantage lies in the necessity to select cells with very similar parameters. These criteria are sometimes not even met by cells from the same production series made by the same battery cell manufacturer. A prerequisite for correct operation is an initial state where all cells have the same parameters, namely the voltage and power capacity.

The fact is that a cell with the same capacity can have different voltage curves over a complete recharge and discharge cycle depending very much on the manufacturing process and repeatability of any given manufacturer.

All known competing solutions are based on evaluating the voltage differences between individual cells at any given point in time. They do not make use of the knowledge of power capacity of every cell with respect to the different voltages of the new cells, or the battery bank assembly containing cells of different ages with different voltage and capacity characteristics. They cannot compensate for differences in the capacity of each individual battery cell without fully utilising the power capacity of all the other battery cells in the battery bank.

Comparing cells based on their voltage is very difficult especially for LiFePo4 cells as in this scenario, the conventional balancing solutions are not accurate enough. The supplied and drawn energy of each cell is only an approximation. LiFePo4 cells—unlike all other cell types—have a very flat voltage characteristic, which makes the vast majority of competing solutions difficult to use or completely unusable, especially for these cells.

In known solutions, it is not even possible to supply energy to the cell from another relatively independent source. Known solutions do not use an automatically switched power supply for an auxiliary power supply bus to recharge the weakest cells.

Known solutions also do not allow to power only the communication and measurement of individual cells as they do not contain the auxiliary power supply bus.

Known solutions also do not store the history of cell and bank measurements, they often do not even measure temperature and are unable to predict impending failure of a bank or a cell.

### SUMMARY OF THE INVENTION

The above-mentioned deficiencies are eliminated by the circuit and method described in the present invention.

In contrast to active balancing by converting energy to waste heat, which is known from the state of the art, the present invention allows for supplying energy to the cell from another relatively independent power source or drawing energy from the battery cell without converting this energy into waste heat.

By using the auxiliary power supply bus, it is possible to
(a) recharge in a manner enabling balancing of the different capacities of individual cells or any cell anywhere in the battery bank
(b) power only the communication and measurement of individual cells; this has great benefits:
   (1) when the battery storage is remotely switched off, the cells are not discharged due to electronics still being connected to them—this allows the battery storage to be left off for prolonged periods of time.
   (2) After the battery storage is remotely or manually switched on, it is possible to diagnose the status of each battery cell even if a failure or breakdown of the battery occurred.

Measurements and their evaluation also make it possible to predict failures and to react to their predictions in time.

A circuit for battery storage management according to the present invention includes at least one battery storage containing at least two cells connected in at least one bank, at least one main power supply bus and at least one communication bus, where
at least one bank contains at least one device for controlling the bank;
within each bank containing the device for controlling the bank, the individual cells are interconnected through the main power supply bus and are also interconnected via the main power supply bus with the device for controlling the respective bank;
at least one cell in each bank containing the device for controlling the bank is equipped with at least one cell management device, wherein said cell management device includes at least one measurement device for measuring the cell status indicator;
inside of each bank which includes the device for controlling the bank, there is at least one processor board containing at least one cell management device, and the processor boards inside of each bank which contains the device for controlling the bank are interconnected via the communication bus; the communication bus also connects them to the device for controlling the respective bank; and
each device for controlling the bank contains a control unit for balancing the cells in this bank and memory storage blocks for storing values regarding the history of each cell in this bank.
The circuit also contains an independent power source outside the battery storage and an auxiliary power supply bus, which is powered from said independent power source and connects each device for controlling the bank to the cell management devices contained in this bank.

It is advantageous if
each device for controlling the bank contains a memory block for storing values regarding the history of the bank and also a temperature measurement device and/or a current measurement device;
all banks containing the device for controlling the bank are interconnected through the main power supply bus;
the devices for controlling the individual banks are interconnected through the communication bus; and
the communication bus, the main power supply bus and the auxiliary power supply bus are connected to a central battery storage management device.

The measuring device for measuring the cell status indicator may be selected from a group comprising voltage measurement device, current measurement device, resistance measurement device and temperature measurement device.

A method for battery storage management in any of the above circuits includes the following steps:
a) measuring at least one cell status indicator of the cell, where the cell status indicator is selected from a group comprising temperature, current, voltage and resistance, and storing the time course of this indicator's values in memory of the history of the cell;
b) predicting status of the cells on the basis of the time course established in step a);
c) recharging the cell or of the cells for which a failure is predicted during step b), through the auxiliary power supply bus powered from an independent power source outside the battery storage.

Furthermore, the battery storage management method may include the following steps:
d) measuring the temperature and/or current at the input of each battery bank and storing the time course of at least one of these quantities in memory of the history of the bank;
e) disconnecting the bank or the banks for which at least one of the parameters measured in step d) shows failure and/or disconnecting this bank or the banks for which at least one of the parameters measured in step a) for at least one of the cells contained in said bank indicates a failure of said cell.

If at least one of the parameters measured in step a) indicates a failure of any of the cells, this cell is disconnected and replaced and at least one cell in the bank in which a cell was replaced is recharged through the auxiliary power supply bus.

It is advantageous if at least one measurement device for measuring the cell status indicator and/or at least one cell management device is powered through the auxiliary power supply bus.

In an advantageous embodiment, the measurement in step a) is performed continuously.

Similarly, it is advantageous if the measurement in step d) is performed continuously.

Further advantages will become apparent from the Detailed Description.

### BRIEF DESCRIPTION OF THE DRAWINGS

FIG. 1 shows an example of embodiment of a circuit containing multiple battery storages, each containing multiple battery banks.

FIG. 2 shows a detail of the circuit containing a single battery bank including schematically depicted cells. Measurement devices are also depicted. It is an advantageous embodiment with an auxiliary power supply bus.

FIG. 3 shows a detail of galvanic isolation of the auxiliary power bus with the connection of the cell and the cell management device.

### DETAILED DESCRIPTION

### Definitions

Cell and battery cell are used synonymously. The cells are usually connected in series in order to create a higher voltage battery bank.

Battery bank or battery pack are used synonymously. A battery bank is a set of cells and control and measurement devices on the cells; it also includes a device for controlling the bank. A battery bank usually contains 15-30 individual cells in a single assembly unit. The battery banks are connected in series in order to create a higher voltage battery storage.

The term battery means a battery bank placed in a box.

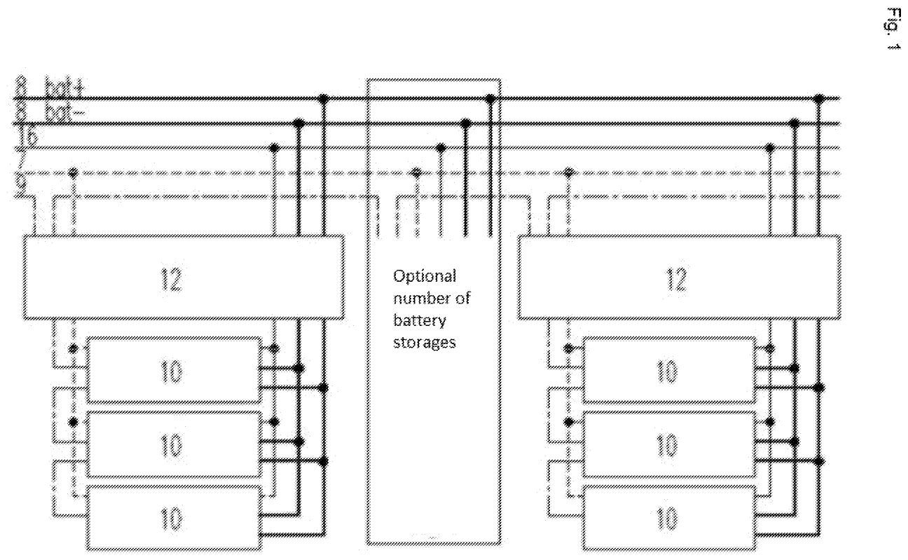

Battery storage—a set of banks and the central battery storage management device, FIG. 1 depicts a master battery storage set which includes multiple basic battery storages conceived as sets of banks with central battery storage management devices for managing these individual basic battery storages.

BMS—Battery Management System

Auxiliary bus, auxiliary power bus and auxiliary power supply bus are used synonymously. The auxiliary power supply bus can supply different parts of the circuit with different voltages.

FIG. 1 shows an example of embodiment where in each case, multiple banks 10 are connected to the central battery storage management device 12. There can be multiple such battery storages that are managed simultaneously, as also shown in FIG. 1. The number of cells as well as the number of banks in individual storages can vary according to voltage requirements.

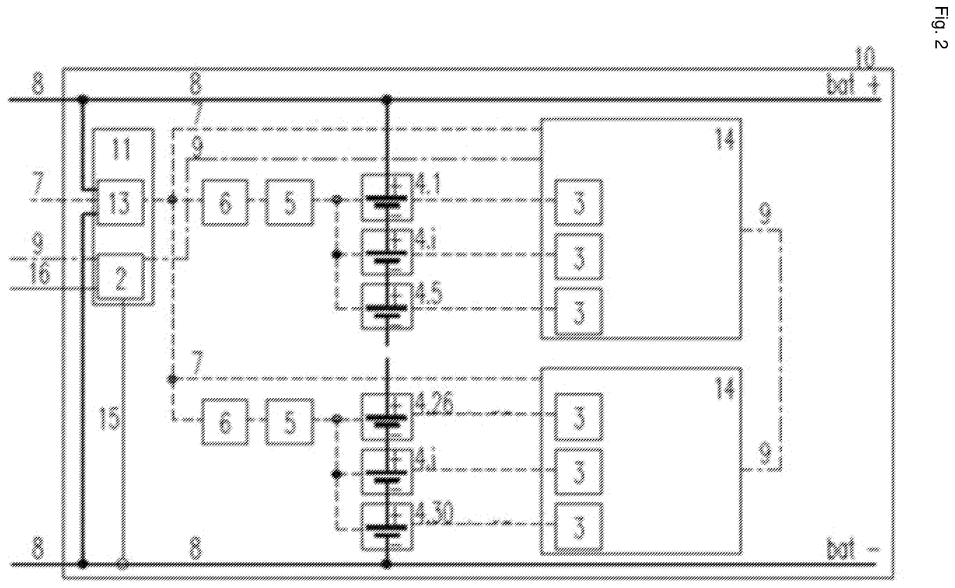

FIG. 2 illustrates an advantageous embodiment of a single bank 10. The battery storage contains at least two cells 4.i, where i is a natural number between 1 and the total number of cells in a single bank, connected in at least one bank 10, at least one main power supply bus 8 and at least one communication bus 9. At least one bank 10 contains at least one device 11 for controlling the bank. In an advantageous embodiment, each bank 10 contains such a device 11. All banks 10 containing the device 11 for controlling the bank are interconnected through the main power supply bus 8; in an advantageous embodiment, they are connected in series. Within each bank 10 containing the device 11 for controlling the bank, the individual cells 4.i are interconnected through the main power supply bus 8, again, in an advantageous embodiment, they are connected in series in order to achieve a higher voltage of the given bank 10 and, as a result, of the entire battery storage. Individual cells 4.i are also connected to the device 11 for controlling the respective bank via the main power supply bus 8.

At least one cell 4.i in each bank 10 containing the device 11 for controlling the bank 10, or, in an advantageous embodiment, all cells 4.i in all banks, is or are equipped with at least one cell management device 3. The cell management device 3 includes at least one measurement device for measuring the cell status indicator, wherein the measuring device for measuring the cell status indicator is selected from a group of voltage measurement device, current measurement device, resistance measurement device and temperature measurement device.

Inside of each bank 10 containing the device 11 for controlling the bank, there is at least one processor board 14 containing at least one cell management device 3. The processor boards 14 inside of each bank 10 which contains the device 11 for controlling the bank are interconnected via the communication bus 9, where, in an advantageous embodiment, this interconnection is in series. The processor boards 14 are also connected to the device 11 for controlling the respective bank via the communication bus 9.

The devices 11 for controlling the individual banks are interconnected through the communication bus 9; in an advantageous embodiment, this connection is in series. Each device 11 for controlling the bank 10 contains a control unit for balancing the cells 4.i in this bank, which may take the form of a microprocessor board 2. The device 11 for controlling the bank 10 also contains a DC/DC divider 13, to which, in a advantageous embodiment, a 48 V or 96 V voltage is supplied from the batteries (depending on whether the bank 10 is a 48 V or a 96 V design); it is also supplied with a 24V voltage, e.g. from an external source. In an advantageous embodiment, 12V/3 A are then supplied to the auxiliary power supply bus 7 from the DC/DC divider 13. Thus, the invention uses an automatically switched power source for the auxiliary power supply bus in order to communicate and measure all the parameters of individual cells.

The main power supply bus 8 can be powered e.g. by a DC/DC converter using photovoltaics and this main power supply bus serves for basic recharging of the cells 4.i and their discharging into appliances.

The auxiliary power supply bus 7 may be powered by the voltage of the entire battery bank or by any independent power source outside the battery storage, such as an external low voltage network supply.

The device 11 for controlling the bank 10 also contains memory blocks for storing values regarding the history of each cell 4.i of said bank 10, and a memory block for storing values regarding the history of the bank 10 and also a temperature measurement device and/or a current measurement device. The data on history of the cells 4.i include, for example, the recorded currents, voltages, resistances or temperatures as functions of time obtained by the measurement devices contained in the cell management device 3. Similarly, the data on history of the bank include recorded data on the measurement of, for example, temperature and current as functions of time at the level of the device 11 for controlling individual banks. FIG. 2 shows the measurement of current 15 and an emergency shutdown 16.

The communication bus 9 and the main power supply bus 8 are connected to the central battery storage management device 12. In an advantageous embodiment, this device includes a control switch, a power disconnect switch and a block for local and/or remote management of the battery storage.

Not all banks 10 need to be equipped with the device 11 for controlling the bank; similarly, not all cells need to be equipped with the cell management device 3. However, in the most advantageous embodiment, each bank 10 has its own device 11 for controlling the bank and each cell has its own cell management device 3.

In an advantageous embodiment, the measurement device for measuring the cell status indicators, and, in particular, the temperature measurement device, is connected to both power connection contacts of the cell 4.i.

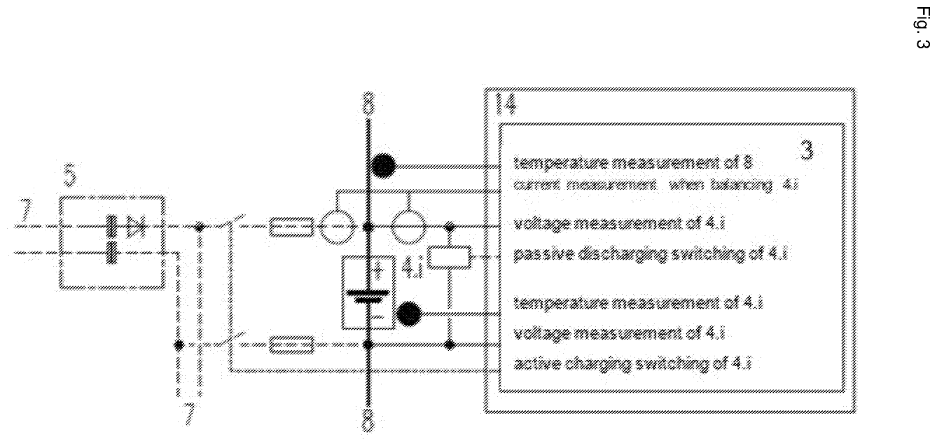

A detail of the circuit containing one cell 4.i and its associated cell management device 3 is shown in FIG. 3. It can be seen that the cell management device 3 can provide for measurement of the temperature of the conductor, specifically the conductor of the power supply bus 8, measurement of the current during balancing of the cell 4.i, measurement of the voltage of the cell 4.i and measurement of the temperature of the cell 4.i. It can also provide for switching of passive discharging of the cell 4.i and switching of active recharging of the cell 4.i.

The bank 10 may contain 3×5 cells 4.i (i.e. 48 V) in one advantageous embodiment, and 6×5 cells (i.e. 96 V) in another advantageous embodiment. Based on that, the power supply bus 8 supplies either +48 V or +96 V. In an advantageous embodiment, five cells 4.i are connected to the processor board 14.

Embodiment with the auxiliary power supply bus 7 connected to an independent power supply is advantageous. This auxiliary power supply bus 7 connects each device 11 for controlling the bank 10 to the cell management devices 3 contained in this bank 10, where this auxiliary power bus 7 is also connected to the central battery storage management device 12.

In the example of embodiment, the auxiliary power supply bus 7 is used as a power source for a 12 V 10-20 KHz inverter-recharging current source 6. Block 5 for galvanic isolation of the auxiliary bus 7, which contains capacitors, is also included. Capacitors connected in series, which are also the source of current for recharging the cells are used for galvanic isolation. The MOSFET transistors are used to switch on recharging for the selected cell 4.i, in an advantageous embodiment, for one of the five cells 4.i which are connected to the same processor board 14. Multiple cells 4.i connected to the same processor board 14 may be recharged, for example, using a method in which the cells 4.i being recharged alternate as needed in cycles lasting for a couple of seconds. Following rectification using a diode, the cell is recharged with a current that varies slightly based on the voltage on the battery cell. By accurately measuring the voltage and current supplied to the cell, a processor unit in the cell management device 3 can very accurately calculate the capacity supplied to each cell. A detail of this circuit is shown in FIG. 3.

The auxiliary power supply bus 7 also provides power to the processor board 14 for measuring the temperature, voltage and current of each cell 4.i. The power source is the auxiliary power supply bus 7; the power supply of the processor board 14 is thus independent of the status of the cells. In FIG. 2, the power connections of both depicted processor boards 14 are drawn near the upper left corner of the processor boards 14.

In the solution according to the present invention, precise or stabilised sources of current for recharging individual cells are not required, but the energy supplied to and drawn from each cell is measured accurately and quickly.

Differences in the capacities of individual cells are determined and confirmed especially in states close to full charge or close to full discharge. This is used in subsequent recharge and discharge cycles; weaker cells are preventively recharged or discharged before reaching near-full discharge or near-full recharge state. This approach enables a cheap and simple hardware solution to balancing. This solution is also perfectly suited for LiFePo4 cells.

In contrast, all known competing solutions are based on evaluating the voltage differences between individual cells at any given point in time.

The method according to the present invention is based on the differences between the energy supplied to and drawn from each cell, which makes it possible to produce battery banks using cells with slightly different voltages at the same amount of energy stored in the cell. This function could be called, for example, power balancing. The circuit uses the auxiliary power supply bus 7 which enables to:
a) recharge any cell anywhere in the battery bank and thus balance the different capacities of cells. Power capacities of each cell are compensated so that the power capacity of all other battery cells is fully utilised. The solution makes it possible to recharge very discharged or undercooled individual cells of the battery bank 10 using a specific method using the auxiliary power supply bus 7 in cases where switching on and recharging using the main power supply bus would lead to the breakdown of one or more cells in the battery bank 10. Using this method, it is possible for battery banks 10, which cannot even be put into operation without damage to the individual cells of the battery bank by utilising known conventional solutions, can be brought into operation in a manner requiring no human intervention. In case of overheating of the cell, such cell is usually disconnected and replaced. The replaced cell is then usually recharged via the auxiliary power supply bus 7.
b) power only the communications (i.e., connection via the communication bus 9 and the measurement devices on the individual cells, resulting in significant advantages:
   (1) when the battery storage is remotely switched off, the cells are not discharged due to electronics still being connected to them; this allows the battery storage to be left off for prolonged periods of time.
   (2) After the battery storage is remotely or manually switched on, it is possible to diagnose the status of each battery cell even if a failure of the battery occurred.
   For example, some cells are discharged below the minimum voltage threshold or even short circuited. Depending on the type of failure, the storage or a part of it, i.e. selected banks 10 and/or selected cells 4.i, can be put into a status outside full operation, but only until the weakest cells are recharged to a voltage level allowing the storage to be connected to normal operation and further recharged in normal mode.

The independently powered auxiliary power supply bus 7 allows the weakest cells of the battery bank to be recharged to a voltage level at which the main recharging circuit for all cells can be switched on via the main power supply bus 8. By slow specific recharging and temperature monitoring of each cell, the independently powered auxiliary power supply bus 7 allows heating up the cells to a higher temperature which enables the main power recharging of the battery bank to be switched on. The independently powered auxiliary power supply bus allows determination of the detailed specific status of disconnected and possibly broken-down battery bank using remote management.

According to the present invention, active balancing means supplying energy to the cell from another relatively independent power source without converting this energy into waste heat or drawing energy from the battery cell. The present invention proposes just such a form of active balancing. Auxiliary power supply bus 7 is used for active balancing.

A distinct advantage over other commonly used methods is:
prediction of failures associated with differently aging individual battery storage cells;
active balancing of the capacities of individual cells by using the total energy of the battery storage and redirecting this energy to the weakest cells in the entire storage;
the possibility of using cells with slightly different parameters without limiting the total maximum capacity of the battery storage. As a rule, a maximum of 2-4% of the difference in cell capacities;
use of the auxiliary power supply bus 7 (12-24 V-15 VA) only for recharging selected cells and for supplying power to the measurement and communication circuits of each cell. This enables to diagnose even such a battery storage which is out of operation due to failures of some cells; moreover, thanks to the use of the auxiliary power supply bus 7, which is powered from an independent source, measurements and communications do not draw power from the battery storage.
the option to also power the auxiliary power supply bus from an independent power supply or a power supply with a backup.

The method of measurement of the required quantities, including the quantities serving as indicators of the status of the individual cells is clearly visible in FIG. 2 and, in particular, the detail in FIG. 3. It is not always necessary to measure all of these quantities, but more extensive measurements make the predictions more accurate.

In an advantageous embodiment, prediction of failures is based on accurate measurement of the current-voltage characteristics of each cell, temperature measurement and temperature rise. Knowledge of the entire history of each cell 4.i and each battery bank 10 from the first commissioning to the decommissioning of the given battery bank 10 is used. In particular, the typical characteristics of the cell 4.i, its temperature rise and its voltage depending on the power supplied and drawn by each cell, are used.

Everything is measured as a function of time and, in an advantageous embodiment, the measurements are taken for each cell; if the storage is running nonstop, an advantageous embodiment involves measurement devices in each cell. Measurements at the current interconnections between cells are advantageous, ideally performed during normal operation in both the recharging and discharging state of the battery storage and at all normal operating temperatures.

The comparison of voltages at current load (recharging and discharging) i.e. also the power capacity with monitoring of temperature changes of each cell is used to very accurately identify changes in the properties of each cell. A change in the internal resistance of the cell will usually result in a higher rise of temperature of the cell at higher current loads, and, in an advantageous embodiment, these changes are also continuously monitored.

Prediction of failures associated with increased contact resistance of connectors and power conductors is ensured by measuring the temperature rise of connector conductors using semiconductor temperature sensors.

The status of the battery when the battery storage was first commissioned, as well as the status after some cells in an older battery storage were replaced shall be used as the reference baseline. Battery storages are usually manufactured using new cells.

Active balancing is handled via the auxiliary power supply bus 7, which can be powered either from the battery storage or from an independent external power supply.

Failure prediction is possible at different stages—from new cells to breakdown and shutdown of the storage. The difference in cell capacities may vary according to cell types and manufacturers as well as operating experience. Therefore, it is possible to:
1. indicate full operation with no failed cells
2. detect partial loss of cell capacity and, if necessary, recharge it through active balancing when the entire storage is being discharged. In this way it is possible to balance any cell in the storage. High efficiency is achieved by using DC/DC converters
3. indicate the detection of notifications regarding partially faulty cells that allow unrestricted operation for local and remote storage management. Cell capacity difference within 3-5% or more
4. use passive balancing of an individual cell to prevent exceeding the maximum cell voltage when recharging to full storage capacity. Cell capacity difference may be within 5-8% or more
5. alert the local and remote storage management with a notification that the maximum storage capacity will be limited. Cell capacity difference over 8% or more
6. operate with a limited maximum storage capacity
7. notify in advance that there is a risk of storage shutdown (due to e.g. overheating of a certain cell). Cell capacity difference over 10-15% or more
8. change the mode of operation if other circumstances permit
9. shutdown of the entire storage with local and remote measurement of each cell in the storage for accurate failure diagnostics

During operation, but also when approaching the end of life of the battery storage, there are typically 1-2 faulty cells in the entire battery storage at first, and replacing them will allow the entire battery storage to operate at the maximum power of each cell without having to replace all the other older cells in the battery storage.

The proposed solution also allows the use of slightly different capacities of individual cells in the manufacture or repair of the storage without limiting the maximum usable capacity of the storage. A major benefit lies in minimising unexpected battery storage downtime and achieving maximum reliability in battery storage operation and safety.

The battery storage must not be operated with damaged cells. A damaged cell is defined as a condition of the cell where it is incapable of operation after a breakdown.

All other stated parameters, such as the cell capacity percentage, temperatures or voltage limits may be parameterised, that is, entered into the processor control unit or units within the bank management device 3 and/or within the device 11 for controlling the bank and/or within the central battery storage management device 12, and may vary based on the types of the used batteries or user requirements. All measured voltage, temperature and current values, as well as modes of operation are stored in the internal memory of the processor unit or units also within the bank management device 3 and/or within the device 11 for controlling the bank and/or within the central battery storage management device 12 for the duration of the battery storage operation and are used to perform analyses of the reliability of the operation and any malfunctions of the battery storage. At the same time, all these values are available for remote management on a centralised server at any time.

Normally, cells degrade gradually, but in rare instances they fail completely within one recharge and discharge cycle. However, such cells have manufacturing defects and should not be used in the production of battery packs. The normal degradation of the weakest cells to a state unsuitable for operation takes several weeks or months.

In practice, it is common for some cells to age slightly faster than the average lifetime. Taking into account an operating cycle in the range of 20-80% of the battery capacity, a 10% drop in capacity of one cell compared to other cells should not limit operation without the need for balancing.

BUT . . . this weaker cell is being charged in the range of 10-90% of the capacity of this one weaker cell; this starts to accelerate its aging compared to the other cells. This fact will serve as a basis for issuing a notification that there is one weaker cell in the battery pack and the expected lifetime of this battery pack is shorter than the expected lifetimes of other battery packs.

As time goes by, the cell will age more and more quickly and it will be necessary to supply extra energy to this cell (only in the discharge mode), in such an amount that its capacity as the weakest cell in the battery pack is not depleted below 10%. That is because discharging to a lower level would only accelerate further aging of this cell.

According to the present invention, this fact will serve as a basis for issuing a notification regarding the need to perform a service intervention and to replace the cell as a precautionary measure before the battery pack is shut down due to breakdown of the cell. But the battery pack is still in use without any limitation on the use of its total maximum capacity.

The next stage in the further decline of the capacity of this weakest cell is a status when the power supplied to the weakest cell by balancing is no longer sufficient and its capacity drops by over 20% of the capacity of the strongest cell in the battery pack. Then a situation occurs in the stage of discharging of the battery pack to the maximum usable capacity when the weakest cell can no longer be discharged (the voltage would drop below the lower permissible threshold and the cell would be in danger of being destroyed) and it is necessary to shut down the entire battery bank 10. At this stage, operation of the battery pack is possible, but with power limited based on the weakest cell.

At the same time, in an advantageous embodiment, the temperature of each cell is continuously monitored in all modes and if the temperature of any cell rises for example by over, e.g. 10° C., this fact will serve as a basis for issuing an alert that this cell is likely to fail. If the temperature of any cell rises by over 20° C. compared to other cells, the load on the battery bank 10 will be limited and, at the same time, this fact will serve as a basis for service intervention and replacement of the cell or the entire bank 10. If the temperature of any cell 4.i in any bank 10 or the temperature of conductors exceeds a certain temperature, e.g. more than 75° C., the entire bank 10 will be shut down. In the recharging mode, each cell has the option of passive balancing, where a passive resistor is connected in parallel to the cell, which limits the voltage on the cell so as to prevent overcharging of the cell above the maximum limits set by the manufacturer. It is only used in extreme cases when the battery capacity is over 20% lower than other cells.

The entire process of monitoring voltages, currents and temperatures, connecting active and passive balancing, and communicating with the master Battery Management System is controlled by microprocessor-based units.

Description of the occurrence of cell failures: loss of capacity of the battery due to the degradation of the electrodes and electrolytes, increase in internal resistance or, in exceptional cases, internal short circuit of the battery occur during the operation for all types of battery cells. If the battery is operated according to the manufacturer's recommendations, degradation is usually a continuous process lasting multiple recharge and discharge cycles. In practice, this means a time period of several weeks in the worst case scenario. With a capacity loss of up to 5% in approximately 80% of the cells, the system allows the battery storage to operate up to the maximum capacity without limitation. With a capacity loss of up to 10% in 40% of the cells, the battery storage can be operated up to the maximum capacity without limitation—active balancing occurs. With a capacity loss of up to 20% in approximately 20% of the cells, the storage can be operated up to the maximum capacity without limitation, active balancing occurs-service intervention is recommended and an alert is issued regarding possible drop of the total capacity of the storage. Operation is possible if a cell loses over 20% of its capacity, but the total capacity is limited based on the current status of the worst cell and there is a possibility to shut down the storage due to breakdown of the cell.

If the weakest cell has 30% less capacity, then the total capacity of the storage is 10% less. If the BMS settings are changed for a short period of time (e.g. until the weakest cells are replaced), the storage can be operated without limiting the rated power.

The stated limits of cell capacity percentage drop and the BMS responses are highly dependent on many other parameter setting and operating conditions such as storage temperature, temperature rise of individual cells, existing percentage of the maximum power supplied to or drawn from the battery storage.

Different types of battery cells vary widely, have different basic characteristics and properties, and there are large differences in voltage curves across the operation mode. This applies mainly to conventional LiIon and LiFePo4 cells. In order to achieve higher voltages, cells are connected in series. To extend the lifetime and balance the capacities of individual cells, it is necessary to use some type of cell management—BMS

The prediction—or assumption—is based on the knowledge of cell properties that are known and also measured during operation. The cell voltage and drawn or supplied currents are measured, which are used to calculate the amount of power drawn from or supplied to each cell. It is assumed that all cells were fully charged in one of the previous cycles. This is based on the fact that all cells are connected in series. If it is known that a cell is discharging and its voltage begins to drop faster than that of other cells, or its temperature begins to rise faster than that of other cells, the fact is that the cell has a weaker capacity (or greater internal resistance) than other cells, and it can be assumed that in operation, this cell will be the source of failure of the entire battery pack.

The method for battery storage management according to the present invention includes the following steps:
a) measuring at least one cell status indicator of the cell 4.i, where the cell status indicator is selected from a group comprising temperature, current, voltage and resistance, and storing the time course of this indicator's values in memory of the history of the cell;
b) predicting status of the cells 4.i on the basis of the time course established in step a);
c) recharging the cell 4.i or of the cells 4.i for which a failure is predicted during step b).

If possible, recharging is done continuously from the main power supply bus 8. If there are more significant differences in the parameters of the individual cells 4.i, charging from the auxiliary power supply bus 7 is started and only when the auxiliary power supply bus 7 is not sufficient to charge the weak cells 4.i is the available power of the battery bank limited in order to avoid damaging the weakest cells.

Predicting the failure of a cell 4.i typically means a 5% or larger drop in power capacity for that cell 4.i and/or a difference in the power capacity for this cell 4.i by 5% or more compared to other cells in the bank, the specific value of the drop or difference in power capacity depends on the cell manufacturer and storage setup. If a drop and/or a difference is detected which is evaluated as a prediction of a cell 4.i failure, in the full bank discharging mode, the cell 4.i for which a failure was predicted is recharged via the power supply bus 7

In an advantageous embodiment, step a) is performed continuously.

The method can also be supplemented with the following steps:
d) measuring the temperature and/or current of each bank 10 and storing the time course of at least one of these quantities in memory of the history of the bank;
e) disconnecting the bank 10 or the banks 10 for which at least one of the parameters measured in step d) shows failure and/or disconnecting this bank 10 or the banks 10 for which at least one of the parameters measured in step a) for at least one of the cells 4.i contained in said bank 10 indicates a failure of said cell 4.i.

In an advantageous embodiment, step d) is performed continuously.

Thus, steps a) and/or d) may be performed continuously in an advantageous embodiment.

In an advantageous embodiment, the prediction of the status of the bank 10 or banks 10 on the basis of the time course identified in step d) and the power compensation of the weakest cells in the bank or banks 10 take place between steps d) and e).

If at least one of the parameters measured in step a) indicates a failure of any of the cells 4.i, this cell 4.i is disconnected and replaced and at least one cell 4.i in the bank 10 in which a cell 4.i was replaced is recharged through the auxiliary power supply bus 7.

For example, a replaced cell 4.i can be recharged via auxiliary power bus 7 if it is less charged than the others. If, on the other hand, the replaced cell 4.i is more charged than the other, older cells in the bank, the other cells in the bank are recharged via the auxiliary power bus 7.

The specific parameters that are already considered failure also depend on the cell manufacturer and the storage setup. Typically, a situation is evaluated as a failure when the temperature measured in steps a) and/or d) increases by 15-25° C. or more, or when the current measured in step d) changes by 15-25% or more. A failure of a cell 4.i shall also be evaluated as a situation where the temperature of this cell 4.i increases by 15-25° C. or more compared to other cells in the bank, a situation where the power capacity of this cell decreases by 15-25% or more, and a situation where the power capacity of this cell differs by 15-25% or more compared to other cells in the bank. Some of these situations may occur simultaneously. In the event of a failure of a cell 4.i, both the cell 4.i in question and the bank 10 in which the cell 4.i in question is located shall be disconnected.

In an advantageous embodiment, at least one measurement device for measuring the cell status indicator and/or at least one cell management device 3 is powered through the auxiliary power supply bus 7.

In solutions known from the state of the art, the voltage of cells is evaluated and compared with each other. This solution is limited in that it is necessary for a single battery storage to contain identical cells (matching type, voltage, internal resistance, etc.). Just using cells of the same type but of a different age in a single storage does not allow operating the storage or BMS without limitations.

In contrast to this, in the solution according to the present invention, the comparison is based on the power supplied to and drawn from each cell and only these cell outputs are then compared with each other. In the solution according to the present invention, the power capacity status of the cell determined during the first complete cycle of charging and discharging of the entire battery storage is used as an initial state. The ascertained initial state is stored in the memory of the control unit in the cell management device 3 and is compared with the values measured during operation and complete charge and discharge cycles of the cell. At the same time, the temperature curves of each cell and power conductors at connectors and connections are monitored. Thus, in the solution according to the present invention, the voltage difference between the individual cells is not detrimental.

Based on the evaluation of the change in the power capacity of the cell, by means of comparison with all other cells in the storage and comparison with the initial state of the cell, it is possible to predict the period of drop in the capacity of the cell when:
the capacity of the entire storage will be partially limited;
the capacity of the entire storage will be significantly limited;
failure and shutdown of the entire storage will occur.

Monitoring of all temperature curves for cells and power connections forms an integral part of the prediction.

Therefore, there is a very important difference compared to state of the art solutions.

Unlike other solutions, this allows for cells with multiple different voltage or internal resistance parameters to be used in a single storage without limiting the stored power or the functionality of the storage or BMS. The solution according to the present invention leads to increased reliability and the prediction leads to minimised battery storage downtimes as it allows to provide users with advance information about the expected capacity limitations or shutdowns of the storage before the actual capacity limitation or shutdown of the storage due to critical failures takes place.

It is also possible to predict failures associated with different rates of aging of individual battery storage cells.

### INDUSTRIAL APPLICABILITY

The invention can be used to manage battery storages with cells of any type.

1. A circuit for battery storage management including at least one battery storage having at least two cells (4.i) connected in at least one bank (10), at least one main power supply bus (8) and at least one communication bus (9), where
the at least one bank (10) includes at least one device (11) for controlling the bank;
within the at least one bank (10), the cells (4.i) are interconnected through the main power supply bus (8) and are also interconnected via the main power supply bus (8) with the device (11);
at least one of the two cells (4.i) in each bank (10) is equipped with at least one cell management device (3), wherein said cell management device (3) includes at least one measurement device for measuring the cell status indicator;
inside each bank (10), there is at least one processor board (14) having at least one cell management device (3), and the processor boards (14) are interconnected via a communication bus (9); the communication bus (9) also connects the processor boards to the device (11); and
each device (11) includes a control unit for balancing the cells (4.i) in the respective bank and memory storage blocks for storing values regarding the history of each cell (4.i) in the bank (10);
characterized in that the circuit includes an independent power source outside the battery storage and an auxiliary power supply bus (7), the power supply bus being powered from said independent power source and connecting each device (11) to the cell management devices (3) contained in the respective bank (10).

2. The circuit according to claim 1, wherein:
each device (11) for controlling the bank includes a memory block for storing values regarding the history of the bank (10) and at least one of a temperature measurement device and a current measurement device;
all banks (10) containing the device (11) for controlling the bank are interconnected through the main power supply bus (8);
the devices (11) for controlling the individual banks are interconnected through the communication bus (9); and
the communication bus (9), the main power supply bus (8) and the auxiliary power supply bus (7) are connected to a central battery storage management device (12).

3. The circuit according to claim 1, characterized in that the measuring device for measuring the cell status indicator is selected from a group comprising voltage measurement device, current measurement device, resistance measurement device and temperature measurement device.

4. A method for battery storage management in the circuit according to claim 1, characterized by that it includes the following steps:
a) measuring at least one cell status indicator of the cell (4.i), where the cell status indicator is selected from a group comprising temperature, current, voltage and resistance, and storing the time course of this indicator's values in memory of the history of the cell;
b) predicting status of the cells (4.i) on the basis of the time course established in step a);
c) recharging the cell (4.i) or of the cells (4.i) for which a failure is predicted during step b), through the auxiliary power supply bus (7) powered from an independent power source outside the battery storage.

5. Method according to claim 4, characterized by that it further includes the following steps:
d) measuring the temperature and/or current at the input of each battery bank (10) and storing the time course of at least one of these quantities in memory of the history of the bank;
e) disconnecting the bank (10) or the banks (10) for which at least one of the parameters measured in step d) shows failure and/or disconnecting this bank (10) or the banks (10) for which at least one of the parameters measured in step a) for at least one of the cells (4.i) contained in said bank (10) indicates a failure of said cell (4.i).

6. Method according to claim 5, wherein if at least one of the parameters measured in step a) indicates a failure of any of the cells (4.i), this cell (4.i) is disconnected and replaced and at least one cell (4.i) in the bank (10) in which a cell (4.i) was replaced is recharged through the auxiliary power supply bus (7).

7. Method according to claim 4, characterized in that at least one measurement device for measuring the cell (4.i) status indicator and/or at least one cell (4.i) management device (3) is powered through the auxiliary power supply bus (7).

8. Method according claim 4, characterized by that the measurement in step a) is performed continuously.

9. Method according claim 5, characterized by that the measurement in step di is performed continuously.
